(19) United States
(12) Patent Application Publication
(10) Pub. No.: US 2021/0163717 A1
(43) Pub. Date: Jun. 3, 2021

(54) LEAD-FREE RADIATION SHIELDING SHEET AND MANUFACTURING METHOD THEREFOR

(71) Applicants: Dong Jin AHN, Seoul (KR); RASGO CO.LTD, Seoul (KR)

(72) Inventors: Dong Jin AHN, Seoul (KR); Yeon Ha SHIM, Seoul (KR)

(21) Appl. No.: 17/263,317

(22) PCT Filed: Jul. 25, 2019
(86) PCT No.: PCT/KR2019/009214

§ 371 Date: Jan. 26, 2021

(30) Foreign Application Priority Data
Jul. 26, 2018 (KR) 10-2018-0086955

(51) Int. Cl. C08K 13/02

(52) U.S. Cl. CPC C08K 13/02

(57) ABSTRACT

The present invention relates to a method of preparing a lead-free radiation shielding sheet with excellent shielding performance not only in a high energy (100 kVp) band but also in a low energy (50 to 80 kVp) band and improved durability of the sheet. bands without containing lead. The radiation shielding sheet of the present invention uses antimony (Sb), which has a high shielding rate even in the low energy band instead of lowering the content of tungsten having a relatively lower shielding rate in the low energy band than in the high energy band, thereby increasing the shielding performance in both high energy (100 kVp) and low energy bands. Further, the radiation shielding sheet of the present invention may increase not only durability, but also elasticity, tearing strength, and tensile strength by mixing additives such as zinc oxide with the rubber.

### TECHNICAL FIELD

The present invention relates to a lead-free radiation shielding sheet and a method for preparing the same, and more particularly, to a method for preparing a lead-free radiation shielding sheet with excellent shielding performance even in a low energy band (50 to 80 kVp) as well as a high energy band (100 kVp) and improved durability of the sheet.

### BACKGROUND ART

Radiation has existed from the time of the earth to be created, and we are still living in an environment where radiation is full. Radioactive materials are present in nature and have been artificially made to be used in industrial, medicine, and the like, and types thereof are various.

On the other hand, the gamma rays are electromagnetic waves which are generated from the collapse or transformation of the nucleus and have energy higher than the X-rays, and have a feature of very strong permeability. These gamma rays can be blocked through a metal material having a high density such as concrete, or iron, and lead, but when the metal material is used, there is a problem that the weight of a shielding material is increased due to the high density.

Neutrons are generated when the nucleus collapses or fissions and have no charge, but since high-speed neutrons have large energy of 1 MeV or more, in order to decelerate the high-speed neutrons, a material containing a large amount of hydrogen having a similar mass to the neutrons is used together, and a shielding material is required to be mixed with a neutron absorbing material for absorbing thermal neutrons having low energy in which the high-speed neutrons are decelerated.

In particular, the gamma rays or neutrons may act directly on atoms or molecules to change a main structure of a DNA or protein, and in the case of acting on reproductive cells of an organism, the gamma rays or neutrons may induce mutations to increase a probability of causing malformations. In addition, in the case of acting on the human body, the gamma rays or neutrons may cause diseases such as cancer, and furthermore, there is a problem that the thermal neutrons radiate surrounding materials to contaminate the surrounding environment with radioactivity. In the field where radiation is applied, radiation shielding materials capable of shielding gamma rays or neutrons harmful to the human body and the environment are necessarily required. Conventional gamma-ray shielding materials generally used lead gowns including iron, lead, cement, and the like. Such a lead gown has been used in a sheet form by dispersing and extruding a lead component in vinyl chloride resin (PVC) and rubber components, but has a large weight of about 5 kg to 10 kg, and thus, the fitting feeling is poor and the activity is bad, and thus it is not easily to be worn. In addition, the lead is a heavy metal material and is not easily disposed due to high harmfulness.

In Korea Patent Publication No. 10-2015-0122105, there is disclosed a radiation shielding sheet prepared using tungsten and barium compounds without using lead. However, the sheet prepared by Korea Patent Publication No. 10-2015-0122105 contains a large amount of tungsten, and thus, the weight of the sheet is large and the sheet should be formed in a multilayer. Further, in Korea Patent Publication No. 10-2015-0122105, the reliability of the product is lowered because there is no mention of the shielding rate of the prepared radiation sheet.

In Korean Utility Model Publication No. 20-2017-0002685, there is disclosed a shielding suit having a shielding sheet containing tungsten powder in a polyolefin resin. However, in Korean Utility Model Publication No. 20-2017-0002685, there is disclosed only a sheet that shields the radiation at 50 to 90 kVp of tube voltage to 80% or more, but there is no description or experimental data for how much the shielding rate is in low energy (50 to 80 kV) or high energy (90 kV), and thus, the reliability of the product is deteriorated.

### DISCLOSURE

### Technical Problem

An object of the present invention is to provide a sheet with high shielding efficiency even in a low energy band (50 to 80 kVp) and a high energy band (100 kVp or more) without using lead.

Another object of the present invention is to provide a radiation shielding sheet with a light weight and excellent durability.

### Technical Solution

An aspect of the present invention provides a method for preparing a lead-free radiation shielding sheet comprising the steps of:

mixing tungsten and antimony and peptizing rubber;

putting the mixed tungsten and antimony in the peptized rubber and kneading and solidifying the mixture; and

extruding and molding the solidified mixture at a predetermined thickness,

wherein the rubber is isoprene rubber, nitrile butadiene rubber or mixed rubber thereof, and

the kneading step is performed by mixing 250 to 450 parts by weight of tungsten and 250 to 500 parts by weight of antimony with respect to 100 parts by weight of rubber.

Another aspect of the present invention provides a lead-free radiation shielding sheet,

as a radiation shielding sheet in which tungsten and antimony are mixed in base rubber,

wherein the base rubber is isoprene rubber, nitrile butadiene rubber or mixed rubber thereof,

the tungsten and antimony have particle sizes of 1 to 100 μm, and

the radiation shielding sheet includes 250 to 450 parts by weight of tungsten and 250 to 500 parts by weight of antimony with respect to 100 parts by weight of rubber.

### Advantageous Effects

The radiation shielding sheet prepared in the present invention shows excellent shielding efficiency in both high energy band (100 kVp) and low energy band (50 to 80 kVp), without containing lead. The radiation shielding sheet of the present invention uses antimony (Sb) having a high shielding rate even in a low energy band instead of lowering the content of tungsten having a relatively lower shielding rate in a low energy band than in high energy, thereby increasing shielding performance in both high energy (100 kVp) and low energy bands. In addition, the radiation shielding sheet of the present invention increases elasticity, tearing strength and tensile strength as well as durability by mixing additives such as zinc oxide and the like with rubber.

### DESCRIPTION OF DRAWINGS

FIG. 1 shows a photograph of a mixture solidified through a kneading step,

FIG. 2 illustrates a sheet formed by pressing the mixture of FIG. 1 at a predetermined thickness and FIG. 3 illustrates a final product formed by vulcanizing the sheet of FIG. 2.

FIGS. 4 to 7 illustrate radiation shielding test reports of a radiation shielding sheet prepared in Example 1.

FIG. 8 illustrates a lead-free test report of the radiation shielding sheet prepared in Example 1.

### MODES OF THE INVENTION

Hereinafter, embodiments and Examples of the present invention will be described in detail so as to easily implement those skilled in the art.

Terms used herein are used only to describe specific embodiments, and are not intended to limit the present invention. A singular form may include a plural form unless otherwise clearly opposed in the context. In the present invention, it should be understood that the term “comprising” or “having” indicates that a feature, a number, a step, an operation, a component, a part or a combination thereof described in the specification is present, but does not exclude a possibility of presence or addition of one or more other features, numbers, steps, operations, components, parts or combinations thereof, in advance.

A lead-free radiation shielding sheet of the present invention includes a step of mixing metal powder and peptizing rubber, a kneading and solidifying step, and a sheet molding step.

First, in the mixing of the metal powder, tungsten and antimony are mixed with a mixer. The tungsten and antimony have particle sizes of 1 to 100 μm.

The rubber may be isoprene rubber, nitrile butadiene rubber or mixed rubber thereof. As the rubber, isoprene rubber and nitrile butadiene rubber are used to increase durability of the shielding sheet.

The rubber peptizing step is a process of mechanically cutting molecular chains of raw rubber (e.g., crude rubber) and loosening twists between the molecules in a chain state using a kneader, etc. to lower the polymerization, decrease viscosity, and increase plasticity.

In the rubber peptizing step, zinc powder (using zinc oxide), an oxidizing agent (vulcanizing agent), or mixed additives thereof may be added to the rubber. As the oxidizing agent (vulcanizing agent), sulfur, a thiocarabmate accelerant, or a thjuram accelerant may be used.

The rubber and the additives may be mixed in a weight ratio of 1:0.01 to 0.15.

The radiation shielding sheet of the present invention may increase not only durability, but also elasticity, tearing strength, and tensile strength by mixing additives such as zinc oxide with the rubber.

The kneading and solidifying step is a step of kneading and solidifying the mixed tungsten and antimony in the peptized rubber.

In the kneading and solidifying step, the mixture of rubber, tungsten, and antimony may be repeatedly pressed with a kneader (2 roll mill). In order to obtain a solid material in which the metal powder is uniformly dispersed in the rubber, a process of cutting the solid material through the kneader and re-putting the solid material into the kneader may be repeated several times.

The kneading and solidifying step may be performed by mixing 250 to 450 parts by weight, preferably 350 to 450 parts by weight of tungsten and 250 to 500 parts by weight, preferably 300 to 420 parts by weight of antimony, with respect to 100 parts by weight of rubber.

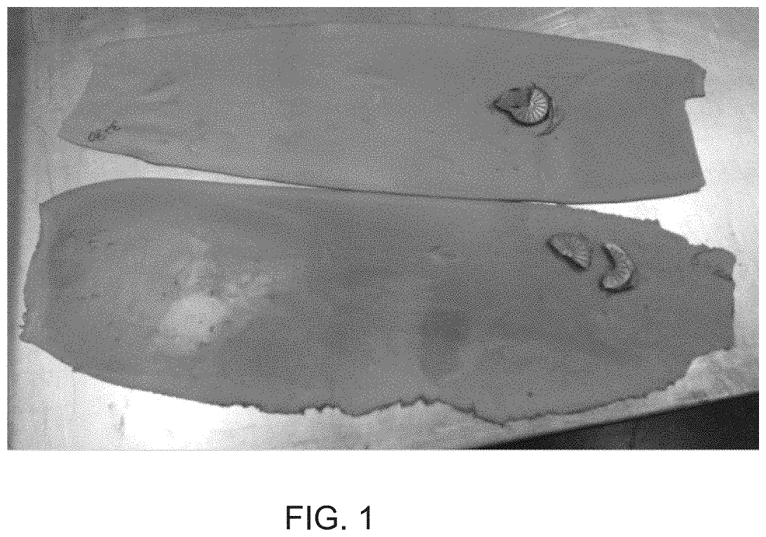

FIG. 1 shows the rubber mixture spread through the kneading and solidifying step. Referring to FIG. 1, the solidified mixture is in a solid state, but has a predetermined elongation force to be deformed in shape.

In the kneading and solidifying step, 70 to 150 parts by weight of gadolinium oxide may be added and mixed with respect to 100 parts by weight of the rubber.

The kneading and solidifying step may be performed by adding and kneading additives such as zinc powder (using zinc oxide) and an oxidizing agent (vulcanizing agent), as in the rubber peptizing step.

The method for preparing the radiation shielding sheet of the present invention uses antimony (Sb), which has a better shielding range than tungsten in a low energy band, instead of lowering the content of tungsten, thereby significantly increasing shielding performance in the low energy band while maintaining shielding performance in high energy (100 kVp). In the present invention, instead of using the content of tungsten to a minimum, the weight of the sheet may be reduced by using antimony, which has a lower weight than tungsten.

Tungsten, antimony, and gadolinium oxide (Gd₂O₃) used in the present invention may effectively block X-rays and gamma rays.

In addition, in the present invention, the rubber is mechanically cut and peptized and metals such as tungsten are mixed therein, and thus, the shielding rate is higher than that of using a polymer fiber as a support and the dispersed metal may be stably held.

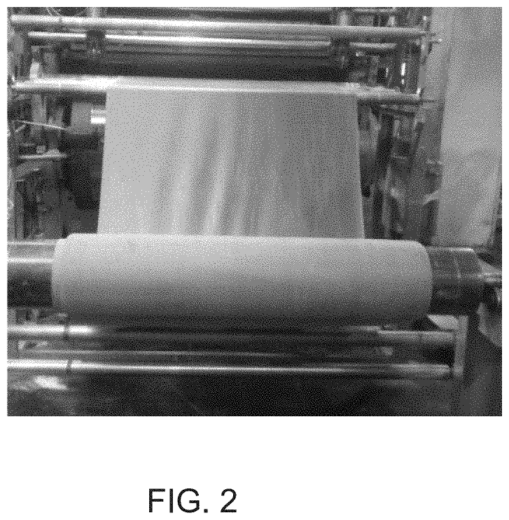

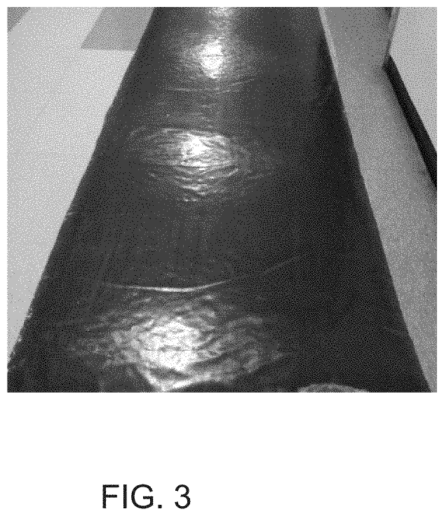

FIG. 2 illustrates the sheet of FIG. 1 pressed to a predetermined thickness, and FIG. 3 is a final radiation shielding sheet obtained by vulcanizing the sheet of FIG. 2.

The extruding and molding step is a step of preparing a sheet by extruding and molding the mixture solidified through the kneading and dispersing step. The extruding and molding step may include a step of pressing and vulcanizing the solidified solid material. The pressing step is a step of preparing the sheet of FIG. 2 by pressing the solidified mixture of FIG. 1 to a predetermined thickness by calendar processing (4 rolls). In addition, the vulcanizing step is a step of preparing the shielding sheet of FIG. 3 by vulcanizing the pressed sheet using equipment called a rotor Q.

According to the method of the present invention, a neutron shielding sheet may be prepared, and the neutron shielding sheets may be laminated on the top and bottom of the radiation shielding sheet. In addition, in the method of the present invention, a neutron shielding film may be interposed between the radiation shielding sheets.

The neutron shielding film may be prepared by mixing the carbon powder with polyethylene resin and forming a film. The carbon powder may be used in 5 to 15 parts by weight based on 100 parts by weight of the polyethylene resin. The carbon powder may include carbon nanotube, carbon fiber, graphite or nanodiamond, preferably graphite and nanodiamond.

In another aspect, the present invention relates to a lead-free radiation shielding sheet.

The lead-free radiation shielding sheet of the present invention is a sheet formed by dispersing tungsten and antimony in base rubber.

The base rubber is isoprene rubber, nitrile butadiene rubber, or mixed rubber thereof.

The radiation shielding sheet includes 250 to 450 parts by weight of tungsten and 250 to 500 parts by weight of antimony based on 100 parts by weight of rubber.

The particle sizes of tungsten and antimony may be 1 to 100 μm.

The radiation shielding sheet may further include 70 to 150 parts by weight of gadolinium oxide with respect to 100 parts by weight of the rubber.

The lead-free radiation shielding sheet may include zinc oxide (zinc powder), an oxidizing agent (vulcanizing agent), or a mixed additive thereof. The oxidizing agent (vulcanizing agent) may be sulfur, a thiocarabmate accelerant, or a thjuram accelerant.

The lead-free radiation shielding sheet may refer to the preparing method described above.

### EXAMPLE 1

270 g of tungsten and 450 g of antimony of 10 μm in size were mixed with metal powder for 30 minutes with a V-mixer. On the other hand, 100 g of nitrile butadiene raw rubber, 3 g of zinc powder, 1 g of thjuram accelerant (TT), etc. were put in a kneader (two rolls) and peptized for 30 minutes. Then, the mixed metal powder was added to the kneader and kneaded and dispersed for 60 minutes again. The prepared mixed solid was calendar-finished (4 rolls) and pressed to a predetermined thickness. The sheet pressed to a predetermined thickness was vulcanized using equipment called a rotor Q. The thickness of the prepared sheet was 0.77 mm.

### Comparative Example 1

A radiation shielding sheet from RASGO (product name of ras-one), which has been sold, was selected as Comparative Example. A sheet was prepared in the same manner as in Example 1 except for using 720 g of tungsten without using antimony as metal powder (sheet thickness of 0.77 mm).

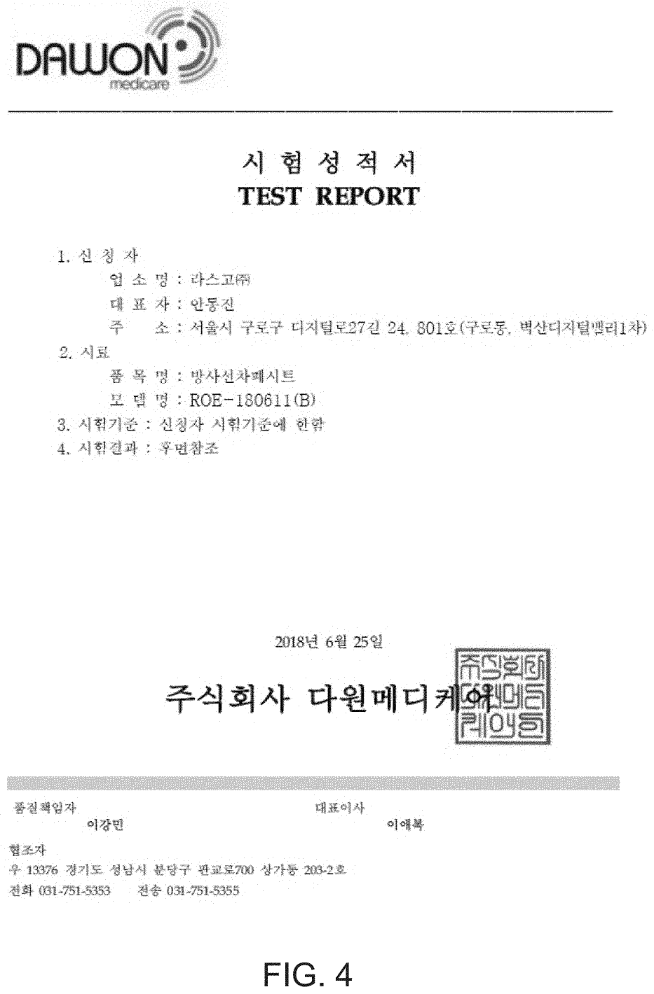

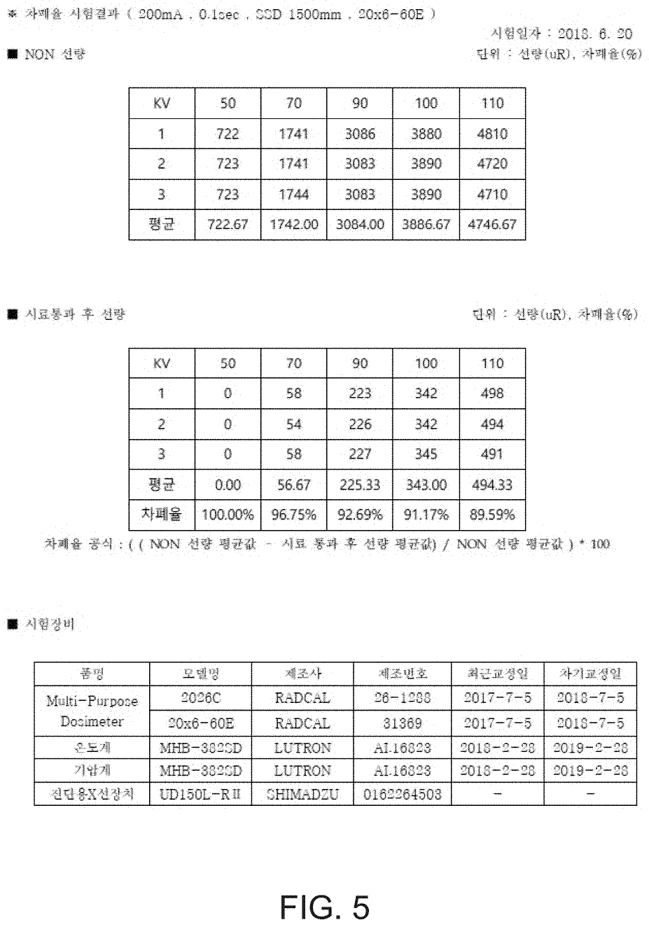

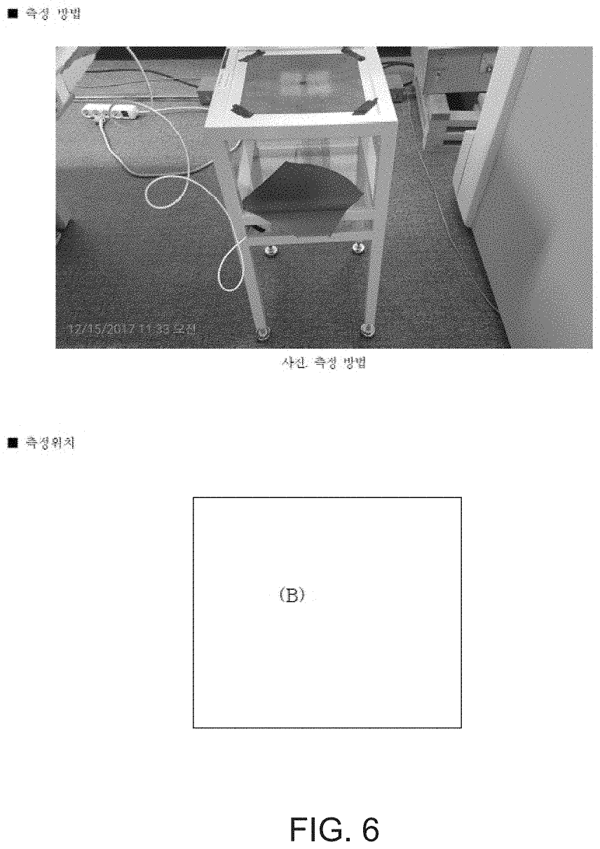

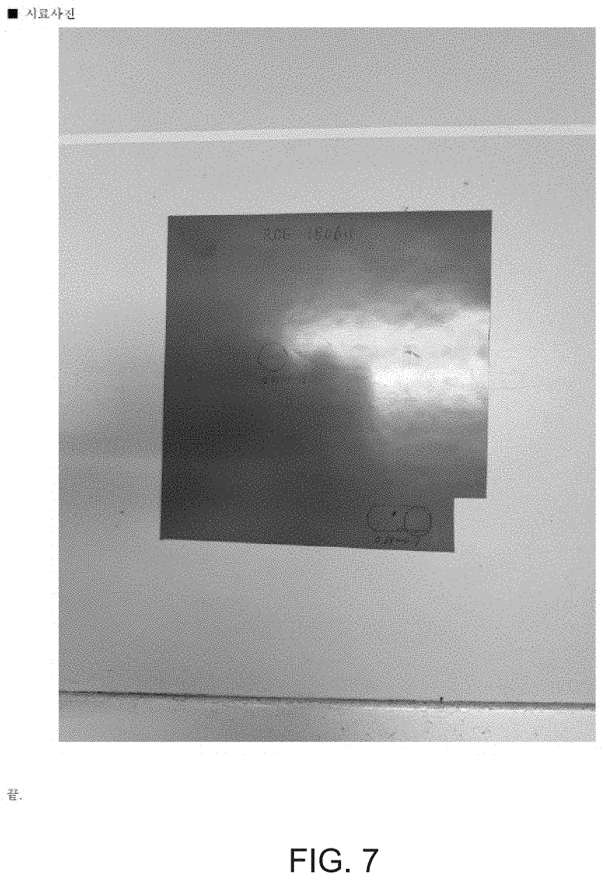

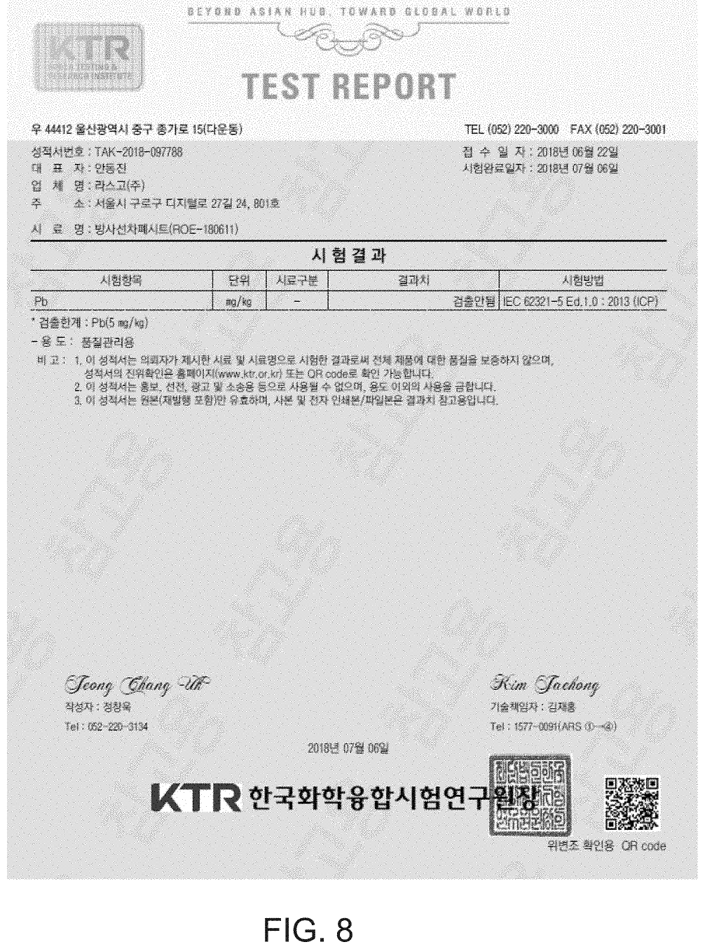

FIGS. 4 to 7 are images of pages 1 to 4 of a test report of the radiation shielding sheet prepared in Example 1 (the sheet thickness was indicated as 0.77 to 0.78 mm in the center of the image on page 4), and FIG. 8 shows a lead-free test report of the radiation shielding sheet prepared in Example 1.

Table 1 below illustrates comparing shielding performances of Example 1 and Comparative Example 1.

Irradiation conditions were 200 mA, 0.1 sec, and SSD 1500mm, and Equation of shielding rate was as follows.

Shielding rate=((NON dose average value−Dose average value after passing through sample)/NON dose average value)×100

TABLE 1

| Classification | 50 kV | 70 kV | 90 kV | 100 kV | 110 kV |
|---|---|---|---|---|---|
| Comparative | 96.98% | 93.3% | 90.3% | 88.8% | |
| Example 1 | | | | | |
| Example 1 | 100.00% | 96.75% | 92.69% | 91.17% | 89.59% |

Referring to Table 1 and FIGS. 4 to 7, results was obtained that Example 1 had a higher shielding rate of about 2.37% than that of Comparative Example 1 in a high energy band (100 kVp or more), and Example 1 had a higher shielding rate of about 3.02% than that of Comparative Example 1 in a low energy band (particularly, 50 kVp). The difference in shielding rate of radiation was 2.37%, for example, a shielding rate that may be secured by increasing the thickness of the shielding sheet by 25% or more (in the case of a shielding sheet prepared using the same component/content ratio). In addition, if the radiation shielding rate at 50 kV was 96.98%, the radiation shielding rate did not satisfy a lead equivalent of 0.25 mmPb, which has been used as the standard in advanced countries such as the United States and Europe, to be rejected as failure (for reference, the shielding rate corresponding to the lead equivalent of 0.25 mmPb of US and England products at 50 kVp was about 98.7%). Since Example 1 can satisfy all shielding standards of the US or Europe in not only high energy but also low energy bands, it can be confirmed that the product can be exported to these countries.

As described above, specific embodiments of the present invention have been described. It is understood to those skilled in the art that the present invention may be implemented as modified forms without departing from essential features of the present invention. The scope of the present invention is defined by the appended claims rather than by the foregoing description, and all differences within the scope of equivalents thereof should be construed as being included in the present invention.

1. A method for preparing a lead-free radiation shielding sheet comprising the steps of:
mixing antimony, bismuth or bismuth oxide and tungsten and peptizing rubber;
putting the mixed antimony, bismuth or bismuth oxide and tungsten in the peptized rubber and kneading and solidifying the mixture; and
extruding and molding the solidified mixture at a predetermined thickness,
wherein the rubber is isoprene rubber, nitrile butadiene rubber, ethylene propylene rubber, chloroprene rubber, or mixed rubber thereof, and
the kneading step is performed by mixing 250 to 450 parts by weight of tungsten and 250 to 500 parts by weight of antimony, bismuth or bismuth oxide with respect to 100 parts by weight of rubber.

2. The method for preparing the lead-free radiation shielding sheet of claim 1, wherein the tungsten and antimony, bismuth or bismuth oxide have particle sizes of 0.1 to 100 μm.

3. The method for preparing the lead-free radiation shielding sheet of claim 1, wherein in the kneading step, 70 to 150 parts by weight of gadolinium oxide is further included with respect to 100 parts by weight of the rubber.

4. The method for preparing the lead-free radiation shielding sheet of claim 1, further comprising:
adding additives such as zinc oxide (zinc powder), an oxidizing agent, or a mixture thereof in the rubber peptizing step or the kneading step.

5. A lead-free radiation shielding sheet as a radiation shielding sheet in which antimony, bismuth or bismuth oxide and tungsten are mixed in base rubber, wherein
the base rubber is isoprene rubber, nitrile butadiene rubber, ethylene propylene rubber, chloroprene rubber, or mixed rubber thereof,
the tungsten and antimony, bismuth or bismuth oxide have particle sizes of 0.1 to 100 μm, and
the radiation shielding sheet includes 250 to 450 parts by weight of tungsten and 250 to 500 parts by weight of antimony, bismuth or bismuth oxide with respect to 100 parts by weight of the rubber.

6. The lead-free radiation shielding sheet of claim 5, further comprising:
additives such as zinc oxide (zinc powder), an oxidizing agent, or a mixture thereof.
